(19) United States
(12) Patent Application Publication
(10) Pub. No.: US 2017/0008790 A1
(43) Pub. Date: Jan. 12, 2017

(54) METHODS FOR REDUCING GREENHOUSE EMISSIONS FROM ANIMAL MANURE

(71) Applicant: RCRA CLEAN ENERGY SOLUTIONS, INC., Sylvania, OH (US)

(72) Inventors: Harry P. Hackett, Techumseh, MI (US); Timothy Joseph Nicholson, Sylvania, OH (US); John Patrick Nicholson, Sylvania, OH (US)

(21) Appl. No.: 15/275,892

(22) Filed: Sep. 26, 2016

Related U.S. Application Data
(63) Continuation of application No. 12/937,400, filed on Dec. 3, 2010, now abandoned.
(60) Provisional application No. 61/045,024, filed on Apr. 15, 2008.

(51) Int. Cl. C02F 11/14; C10L 5/42; C02F 1/66; C05F 3/00; C02F 11/12; C02F 11/04

(52) U.S. Cl. CPC C02F 11/14; C02F 11/121; C02F 11/04; C02F 1/66; C05F 3/00; C10L 5/42; C02F 2103/20

(57) ABSTRACT

Greenhouse gases are lowered in treatment of animal manure from a CAFO by eliminating or reducing anaerobic digestion. The manure product is admixed with drying agents and is suitable for use as fertilizer or fuel while severely curtailing odor at the same time.

### CROSS-REFERENCE TO RELATED APPLICATIONS

This application is a continuation of U.S. application Ser. No. 12/937,400 filed Dec. 3, 2010, now pending, which is the U.S. national phase of PCT Application No. PCT/US2009/040592, filed Apr. 15, 2009, now expired, which claims the benefit of U.S. provisional application Ser. No. 61/045,024, filed Apr. 15, 2008, now expired, the disclosures of which are hereby incorporated in their entirety by reference herein.

### BACKGROUND OF THE INVENTION

1. Field of the Invention

The present invention is directed to reduction of greenhouse emissions associated with animal manure, and other organic waste that is generally anaerobically digested.

2. Background Art

Greenhouse emissions, especially methane and carbon dioxide, but also to a lesser extent nitrogen oxides and other gases, have become under high scrutiny due to their potential to accelerate global warming. There are numerous sources of greenhouse gases, and of course those which have achieved the greatest notoriety are those associated with internal combustion engines, particularly in the vehicular segment, power plant emissions, and emissions from chemical production facilities. However, together, these sources provide only a minor amount of total greenhouse gases. Thus, there is a need to decrease emissions from other greenhouse gas sources. One of these sources is animal manure.

The traditional technique for handling animal manure from a Concentrated Animal Feed Operation (CAFO) is that the manure is washed away from the barn via a sluice, which directs the manure and water to a storage lagoon. The manure then settles to the bottom of the lagoon and sits there in an anaerobic condition, slowly being “digested”. This practice results in an ongoing release of global warming gases (methane, nitrous oxide, and carbon dioxide) from the lagoon to the atmosphere, as well as the release of objectionable odors. Then, on a periodic basis, typically once a year, the lagoon is emptied, the waste manure is recovered from the lagoon and stored, and eventually is spread on the farmland. The amount of digested manure placed on the land needs to be limited in that it is a potentially massive nutrient loading, leading to concerns about soil quality as well as storm water runoff pollution and ground water pollution. Also, the digestion process seriously degrades the fertilizer value of the manure and minimizes the benefit of placing the digested manure on the land. Over 80% of all nitrogen in manure is organic nitrogen. This is the ideal nitrogen product for use as a sustainable “slow-release” fertilizer. The organic nitrogen is stable and the nitrogen is released only through the biological process of mineralization. Digestion, particularly anaerobic digestion, converts most of this valuable stable organic nitrogen into problematic, volatile and soluble ammonium compounds, ammonia, nitrates, nitrous oxides, and methane. Digestion destroys much of the real value of the end product, creates huge unnecessary amounts of greenhouse gases and results in converting stable organic nitrogen into highly leachable materials. Further, the manure recovery process, the storage of the manure, and the placement of the manure on the land all release high levels of objectionable odors.

In addition to problems associated with animal manure, other organic wastes, for example those from pulping, papermaking, etc., are often treated by anaerobic digestion. As is the case with animal manure, this process also generates large quantities of greenhouse gases.

### SUMMARY OF THE INVENTION

The invention is directed to lowering greenhouse gas emissions from animal manure and organic waste, and in conjunction therewith, providing for the economic use of the animal manure or waste. These and other objects have been surprisingly and unexpectedly achieved by treating the manure or waste in such a manner so as to retain its beneficial nutrient qualities without greenhouse gas generation.

### DETAILED DESCRIPTION OF THE PREFERRED EMBODIMENT(S)

The present invention is thus directed to methods of treatment of animal manure (hereinafter, “manure”) and organic waste (both, hereinafter, “waste”) which not only minimizes emission of greenhouse gases, but also allows the treated waste to be reused in ways which increase the value of the waste or actually decrease greenhouse emissions from other industrial processes. In all the embodiments of the subject invention, the waste is not allowed to be digested anaerobically, or its anaerobic digestion is sharply curtailed, thus preventing considerable emissions of greenhouse gases prior to further treatment or use.

In a first embodiment, waste, in particular, animal manure which would ordinarily be directed in the form of an aqueous mixture, into a lagoon, is subjected to dewatering or filtration to remove a substantial amount or all of the particulate solids. Preferably, greater than 60% of the particulate solids are removed, more preferably greater than 80% (percentages herein are weight percentages based on solids), and most preferably greater than 90% to 95%. The dewatered waste is still relatively moist, and may even be in the form of concentrated slurry. A relatively “dry” form is preferred.

The dewatered waste is then admixed with an inorganic particulate drying material and further processed. The amount of drying material added will be dependent on both the form of the product desired and its end use. For example, if the product is to be in the form of a pumpable slurry, either a greater amount of water may be left in the dewatered product, or less drying agent can be added, or both. However, it is preferred that the drying agent is added in such an amount that the product can be granulated, pelletized, or pressed into briquettes. Examples of suitable inorganic drying agents include, but are not limited to, limestone, lime, lime kiln dust, cement kiln dust, combustion ashes from coal or wood such as coal ash, wood ash, fly ash, etc., or wet-scrubber residuals. Chemical flocculants may be added, preferably before dewatering, to assist in removing very fine particulates.

In the above embodiment, it is preferable that the sluice water be recycled following dewatering, for example by using it again to sluice the barns or feed lots, in the case of animal manure, or used in industrial processes in the case of organic waste.

The mixing is preferably conducted in a low-energy mixer such as a screw feeder, pug mil, or auger, as disclosed in U.S. Pat. No. 4,981,600, which is incorporated herein by reference. However, numerous methods of mixing can be used.

As a result of the use of this embodiment, a considerable portion, preferably nearly all the waste, preferably manure, is prevented from entering the lagoon. This has numerous benefits, the first and foremost being that the generation of greenhouse gases by anaerobic digestion is largely prevented. In the United States alone, this could result in a savings of over 100 million tons of greenhouse emissions per year. In 2003, the National Research Counsel published the book Air Emissions from Animal Feeding Operations, which stated on page 24:

Facing the need for defensible information on air emissions from AFO's in a timely manner is a major challenge for EPA and USDA. Neither has yet addressed the need for this information in defining high-priority research programs. Neither has asked for nor secured the level of funding required to provide the necessary information. Each has pursued its regulatory and farm management programs under the assumption that the best currently available information can be used to implement its program goals.

The committee believes that the scope and complexity of the information needed by these agencies, as well as the potential environmental impacts of air emissions from AFO's, require a concentrated, focused, and well-funded research effort.

In the Sep. 4, 2000 issue of TIME, Dr. James Hansen, NASA's highly respected authority on global warming is quoted as saying: “he suggests going after other greenhouse gases, such as methane, which he thinks has accounted for as much carbon dioxide in the past century as fossil fuels.”

A second benefit is that, for example when manure is the waste, the manure product or “admixture” is easily used in its entirety in an economical manner. For example, since the product is relatively dry (and it is optionally dried further using a drier), and since even if stored, the storage will not be principally anaerobic, the nitrogen values in the manure are retained, making it a more efficient, particularly a longer lasting, fertilizer. The dewatering and mineral drying agent admixing steps, as well as any optional further drying, severely reduce the odor associated with the manure. Thus, if used as fertilizer, the foul odor normally associated with its use will be much less pronounced, and the vector attractant potential also decreases.

The product may also be used as an energy source. It may be fed by itself to a power station burner, but is preferably fed in admixture with coal. The product actually often has the BTU value of Western Coal, when dry, and about 10-15% less when still wet. An advantage of using the product as a fuel is that when the organic waste is manure, or a nitrogen-containing organic waste, nitrogen is generated as ammonia, which can augment the use of injected ammonia to reduce nitrogen oxide (NOₓ) emissions. A further advantage of the method is that the lagoon need not be emptied so regularly, saving the CAFO operators considerable operating expense. While not desired, the product can also be directly landfilled.

In a second embodiment of the invention, the waste is not initially removed from its aqueous source, for example a sluice in the case of manure from CAFOs, but is fed to a lagoon which is equipped with a gas distribution system proximate the bottom of the lagoon, preferably at the bottom. Such a gas distribution system can easily be made from perforated PVC piping, or piping having gas distribution fittings attached. Air or oxygen, preferably air, is injected into the gas distribution system, providing oxygen as well as, in preferred embodiments, agitation. Air entraining agents may be added to the lagoon to assist in aeration. As a result, the lagoon becomes aerobic rather than anaerobic, and the composition of the gas emissions from the lagoon will be altered significantly. Methane generation, in particular, will be reduced.

The lagoon is then emptied on a regular basis (e.g., annually) as usual, and the waste is dewatered as in the first embodiment, and admixed with a drying aid. It should be noted that the drying aid may be incorporated prior to or following dewatering, preferably following dewatering. The product will have a higher concentration of organic material, particularly organic nitrogen in the case of manure than anaerobically digested waste, and the emission of massive quantities of methane will have been prevented. The product can be granulated, pelletized, or briquetted as in the first embodiment, or may be used as a pumpable slurry. It may be used as a fertilizer or as a fuel, as per embodiment one.

If the final product is to be recycled onto farm land, then the drying station will preferably be a low energy mixer (such as a screw feeder) where the recovered waste, preferably manure, will be blended with a drying material (such as limestone, lime, lime kiln dust, cement kiln dust, or combustion byproducts including coal ash or wood ash or wet-scrubber-residuals). The final product will be more suitable for placing on the land in that it will have a higher fertilizer value than the digested waste, and it will have a slower release of nutrients and therefore less storm water runoff pollution and ground water pollution. The odor will be significantly reduced at every step. The vector attraction and public health hazard will be significantly reduced to acceptable levels. In the case of lignocellulosic waste, addition to soil will increase the ability of the soil to absorb and hold water, and will thus not only enable more stable plant growth (for example, when dry conditions are expected), but will reduce runoff as well.

If the final product is to be recycled as an alternative fuel or alternative raw material into an industrial application, (such as the cement, steel, or utility industries), then the drying station may be a direct-contact drier utilizing waste gas, and sweeteners (such as green matter and other CO₂ absorbent/adsorbent/reactive materials) may be added to the recovered waste to reduce the CO₂ concentration in the waste gas. The reasonably dry waste may then be blended with other dry materials (such as limestone, lime, lime kiln dust, cement kiln dust, or combustion byproducts including coal ash or wood ash or wet-scrubber-residuals) in a low-energy mixer (such as a screw feeder). As a site-specific alternative, the waste, waste gas and sweeteners, and other dry materials may be blended together when this process achieves greater reduction in global warming pollutants. The mission of the dryer is twofold: 1) to convert a problematic waste material to a valuable energy or fertilizer resource; and, 2) to significantly reduce the global warming pollutants in the waste gas air emissions. The final product will then be suitable for recycling and use as an alternative fuel or alternative raw material. In drying, the waste admixture can absorb an appreciable amount of CO₂, for example 10-50%, preferably around 25%.

In a third embodiment, the waste is directed to a lagoon in the normal manner, preferably without any solids removal, and an acidic material such as HCl, H₂SO₄, waste pickle liquor, etc., or a basic substance such as gypsum, limestone, lime, lime kiln dust, cement kiln dust, coal or wood combustion fly ash, potash, soda ash, or like compounds are added to the lagoon to ensure that the pH is either in an acid range or basic range wherein anaerobic digestion is suppressed. The acidic or basic substances are preferably admixed with the sluice water prior to entering the lagoon. The pH is preferably lowered to at least a pH of about 6, preferably about 5.5 or lower when it is desired to be acid, or above about 8.5, preferably above 9.0 when it is desired to be basic. Not only is the generation of greenhouse gases suppressed, but the odor is reduced by this process as well.

When the lagoon is emptied, the manure will be dewatered as in embodiments one and two, and then dried. If the lagoon has been acid treated, then the recovered manure will be admixed with drying material, preferably a basic drying material preferably in a high speed mixer such as a pin mixer. The heat of reaction coupled with the energy provided by the mixer will aid in drying the material. If the lagoon has been treated with a base, then optionally an acidic component may be admixed, in either case resulting in a product which is closer to neutral than the pH of the lagoon. The product may be further dried as desired, or may be used as is. It is preferably that the product be substantially neutral, i.e. with a pH between 6 and 8 more preferably between about 6.5 and 7.5, and most preferably about 7.

The final product will be more suitable for placing on the land in that it will have a higher fertilizer value than the digested waste, preferably manure, and it will have a slower release of nutrients and therefore less storm water runoff pollution and ground water pollution. The odor will be significantly reduced at every step. The vector attraction and public health hazard will be significantly reduced to acceptable levels. The final product will also be suitable for use as an alternative fuel or alternative raw material in industrial applications (such as the cement, steel, and utility industries).

The subject invention is also directed to the use of the products of the previously described embodiments.

In one such embodiment, the treated waste product, preferably a manure-based product, is employed as a fertilizer. In this embodiment, the inorganic mineral dryer may be replaced all or in part by fertilizer ingredients such as potassium phosphate, potassium nitrate, ammonium nitrate, urea (organic) and the like, as well as elements from trace minerals such as iron oxides. The drier is thus one which preferably contains at least one of nitrogen, potassium, or phosphorous. The treating processes enhance the production of ammonium from nitrogen-containing waste, which may substantially eliminate generation and loss of ammonia to the atmosphere. The subject invention fertilizers contain much more organically bound nitrogen than manure harvested from lagoons following anaerobic digestion. Thus, less fertilizer per acre is required. The odor associated with the fertilizer is enormously less than that of the raw, digested manure.

The products may also be used to reduce CO₂ and SO₂ emissions in power plants. The effluent gases may be contacted with the waste product, preferably a manure product, either in a fixed bed, fluidized bed, or, when the product is in pumpable slurry form, in a scrubbing column or the like. CO₂ and SO₂ are absorbed by the composition, which is also dried at the same time. The dry product can then be introduced along with coal or oil into a power plant burner. The manure products can also be formulated with “sweeteners”—meaning materials, that when combined with the organic waste stream result in an increased effectiveness of the waste stream to capture CO₂. Examples of sweeteners are: yard waste, pickle liquor, mineral by-products with high surface area, particularly mineral by-products that will create chemical reactions such as pozzolonic, etrangite and syngenite. Preferably, however, the dried products, especially those containing SO₂, are granulated or pelletized to produce fertilizer.

The invention also pertains to lowering NOₓ emissions by introducing ammonia into the hot gases at a proper temperature window. Ammonia is currently employed for such processes. The ammonia in the present process is prepared from the manure products or during their formulation. For example, treating dewatered manure with basic dryers will liberate ammonia. Thus, an integrated plant could be produced where partially dewatered sludge is treated with lime, for example, and gaseous ammonia liberated is transported to an exhaust stream. The ammonia-depleted product is then granulated, pelletized or made into briquettes to form fertilizer or a fuel additive.

The subject invention is particularly directed to a process for reducing greenhouse emissions by treating raw manure by one of embodiments one to three. The products which result from this process are preferably used as fertilizer, fuel, or CO₂, SO₂, or NOₓ removal materials.

The subject invention is further directed to reduction in the odor of manure-based products, by drying a moist or wet manure with a drying agent as previously described, oxygenating the organics contained in the manure, or by altering the pH of the raw manure to decrease the biological activity of the manure. These same methods also comprise a method of decreasing potential health impact of exposure to manure products.

### EXAMPLE NO. 1

A dairy cow CAFO operator uses a sluice system in order to clean out the barns. The manure is then deposited in an outside storage lagoon. The material is kept in the lagoon for approximately one year where it naturally anaerobically digests. This digestion converts stable organic nitrogen into problematic and unstable ammonium, ammonia and methane. The operator treats the material prior to its entering the lagoon and deposits it in a short-term storage tank, where mixing action occurs as well as the possible addition of flocculants or ash. The mixed material is then sent to dewatering equipment, for example a screw press, where free water is squeezed out and approximately 95% of the solids are stripped from the wastewater and the remaining will go to a lagoon. Thus, a 95% reduction in methane creation is expected.

The squeezed material is then diverted to a mixing system where Class F fly ash is added in an amount sufficient to produce a granular, stackable material which provides a stable end-product.

### EXAMPLE B

The same operator as in Example A installs an air handling system is installed in the existing lagoon to distribute air and/or oxygen into the lagoon to convert anaerobic digestion into aerobic digestion. This conversion results in the virtual elimination of methane creation. The aeroboic digestion breaks down the organic nitrogen into ammonium and ammonia. This is a less desirable result than the result obtained in either Example A or Example C, but still results in a considerable decrease in greenhouse gas emission.

### EXAMPLE C

The same operator as in Example A has a dairy cow lagoon. A Class C fly ash is mixed into the lagoon to increase the pH to greater than 9. The operator processes the lagoon as per prior practice, with substantially reduced methane creation.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of decreasing emission of CO₂-equivalent greenhouse gases in a CAFO operation, comprising:
substantially reducing anaerobic digestion of organic waste solids contained in a liquid from a CAFO and preserving organic nitrogen in the liquid in an anaerobic lagoon by increasing the pH of the liquid to above 9.0 or decreasing the pH of the liquid to below 5.5;
concentrating undigested organic waste solids by dewatering; and
neutralizing the concentrated undigested organic waste solids in a mixer, optionally with an addition of a drying agent, wherein the heat of the neutralization reaction and energy input of the mixer result in the formation of a dry admixture.

2. The method of claim 1, wherein the organic waste solids are contained in a sluice liquid containing manure and water, and the step of increasing the pH or lowering the pH of the anaerobic lagoon occurs prior to entry of the sluice liquid into the anaerobic lagoon.

3. The method of claim 1, wherein the pH is adjusted by addition of HCl, H₂SO₄, waste pickle liquor, gypsum, limestone, lime, lime kiln dust, cement kiln dust, coal or wood combustion ash, potash, or soda ash.

4. The method of claim 1, further comprising capturing ammonia liberated during the addition of a drying agent to the organic waste solids.

5. A method of preventing anaerobic decomposition of organic nitrogen of manure in an anaerobic lagoon, the method comprising:
adding an alkaline or acid component to a concentrated manure slurry prior to the slurry's entrance to the lagoon such that anaerobic biological decomposition of the organic nitrogen of the manure while in the anaerobic lagoon is suppressed.

6. The method of claim 5, wherein the alkaline or acid component adjusts the pH of the slurry to a pH of 5.5 or less or 9.0 or higher in the lagoon.

7. The method of claim 5, further comprising concentrating undigested organic waste solids by dewatering to produce a dewatered waste after the lagoon is emptied.

8. The method of claim 5, wherein the dewatering removes more than 90% particulate solids from the slurry.

9. The method of claim 5, further comprising adding a drying agent to the dewatered waste to render the waste suitable for use as a fertilizer/soil supplement.

10. The method of claim 9, wherein the drying agent is limestone, lime, lime kiln dust, cement kiln dust, combustion ashes from coal or wood, or a combination thereof.

11. The method of claim 7, further comprising recycling sluice water from the slurry after the dewatering step.

12. The method of claim 7, further comprising routing the dewatered waste through a direct-contact drier utilizing waste combustion gases as the heat source such that CO₂ is removed from the combustion gases;
capturing CO₂ in the dewatered waste; and
drying the dewatered waste to enhance the waste's effectiveness as a sustainable alternative fuel or alternative raw material for industrial processes.

13. The method of claim 12, further improving the dewatered waste's effectiveness in removing and capturing CO₂ by addition of yard waste, pickle liquor, pozzolonic, etrangite, or syngenite to the waste.

14. The method of claim 7, wherein the dewatered waste, when dry, has a BTU of about 10,000 per pound.

15. A method of decreasing emission of CO₂-equivalent greenhouse gases in a CAFO operation, comprising:
feeding a CAFO manure slurry comprising sluice liquid and anaerobically undigested organic waste solids into an anaerobic lagoon equipped with a gas distribution system capable of aerating a bottom of the lagoon;
activating the gas distribution system by injecting air or oxygen into the gas distributions system;
altering the anaerobic lagoon into an aerobic lagoon while preserving the organic solids in an anaerobically undigested state;
removing the CAFO manure slurry from the lagoon; and
separating the anaerobically undigested organic waste solids from the sluice liquid by filtration.

16. The method of claim 15, further comprising mixing the organic waste solids with a drying agent in an amount capable of rendering the waste solids usable as a fertilizer or a fuel.

17. The method of claim 15, further comprising adding one or more air entraining agents into the lagoon.

18. The method of claim 15, further comprising, after the filtration, routing the organic waste solids through a direct-contact drier utilizing waste combustion gases as the heat source, removing CO₂ from the combustion gases, capturing the CO₂ in the organic waste solids, further comprising drying the organic waste, optionally with the aid of a drying agent.

19. The method of claim 17, further improving the organic waste solids' effectiveness in removing and capturing CO₂ by addition of yard waste, pickle liquor, pozzolonic, etrangite, or syngenite to the waste.

20. The method of claim 18, wherein the dewatered waste, when dry, has a BTU of about 10,000 per pound.
